(19) United States
(12) Patent Application Publication
(10) Pub. No.: US 2025/0267502 A1
(43) Pub. Date: Aug. 21, 2025

(54) DEVICE IDENTIFICATION BEHIND A RESIDENTIAL GATEWAY (RG)

(71) Applicant: CABLE TELEVISION LABORATORIES, INC., Louisville, CO (US)

(72) Inventors: Yunjung Yi, Vienna, VA (US); Rahil Gandotra, Boulder, CO (US); Tao Wan, Ottawa (CA)

(21) Appl. No.: 19/054,520

(22) Filed: Feb. 14, 2025

Related U.S. Application Data
(60) Provisional application No. 63/554,856, filed on Feb. 16, 2024.

(51) Int. Cl. H04W 28/02; H04W 88/16

(52) U.S. Cl. CPC H04W 28/0263; H04W 28/0268; H04W 88/16

(57) ABSTRACT

Various systems, apparatuses, and methods for identifying one or more non-third generation partnership project (non-3GPP) devices and for providing differentiated quality of service (QoS) for the one or more non-3GPP devices are provided. A residential gateway (RG) may be connected to the one or more non-3GPP devices. The RG may receive a request for differentiated QoS for a non-3GPP device of the one or more non-3GPP devices. The RG may bind, based on the request for the differentiated QoS, a non-3GPP device identifier to the non-3GPP device. The RG may transmit, to a core network, at least one of: a protocol data unit (PDU) session modification request or a PDU session establishment request. The RG maps a traffic stream associated with the first non-3GPP device to a PDU session and a QoS flow identifier (QFI) indicative of differentiated QoS.

### CROSS REFERENCE TO RELATED APPLICATIONS

This application claims the benefit of U.S. provisional application No. 63/554,856 filed on Feb. 16, 2024 which is incorporated by reference as if fully set forth.

### BACKGROUND OF THE INVENTION

A fifth generation residential gateway (5G-RG) connects one or more devices in a smaller network to a 5G core network. Some of the devices in the smaller network may be non-third generation partnership project (non-3GPP) devices. The non-3GPP devices cannot communicate with the 5G core network. Examples of such non-3GPP devices include but are not limited to smart televisions, printers, tablets, or appliances etc. Identifying and managing multiple non-3GPP devices is vital in smaller networks with multiple interconnected devices, such as homes, offices, or a home office etc. In such networks, different non-3GPP devices may have different quality of service (QoS) requirements. Therefore, there is a need for a technique to distinguish traffic from the non-3GPP devices and/or to identify the non-3GPP devices connected to the 5G-RG.

### SUMMARY OF THE INVENTION

In various implementations of the present disclosure, a method performed by a residential gateway (RG) is provided. The method comprises connecting to a first non-third generation partnership project (non-3GPP) device. The method further comprises receiving a request for differentiated quality of service (QoS) associated with the first non-3GPP device. The method further comprises binding, based on the request for differentiated QoS, a first non-3GPP device identifier to the first non-3GPP device. The method further comprises transmitting, to a core network, at least one of: a protocol data unit (PDU) session modification request or a PDU session establishment request. The method further comprises mapping a traffic stream associated with the first non-3GPP device to a first PDU session. The first PDU session is established based on at least one of: the PDU session modification request or the PDU session establishment request. The method further comprises mapping the traffic stream to a first QoS flow identifier (QFI) indicative of differentiated QoS.

In an implementation, at least one of: the PDU session modification request or the PDU session establishment request includes the first non-3GPP device identifier.

In an implementation, the non-3GPP device is associated with a default QFI.

In an implementation, the default QFI is shared with one or more non-3GPP devices.

In an implementation, the PDU session modification request is indicative of modifying the default QFI to the first QFI for providing differentiated QoS in the first PDU session.

In an implementation, the request for differentiated QoS is received from one or more of: an operator portal hosted in the RG, or an application function (AF) external to the RG.

In an implementation, the first non-3GPP device identifier is provisioned by the AF.

In an implementation, the method further comprises connecting to a set of non-3GPP devices. The method further comprises receiving, a set of requests for differentiated QOS associated with a set of non-3GPP devices. The method further comprises binding, based on the set of requests, a set of non-3GPP device identifiers to the set of non-3GPP devices. The method further comprises mapping, based on the set of requests, the set of traffic streams to a set of QFIs indicative of differentiated QoS.

In an implementation, the method further comprises mapping at least one of: the set of non-3GPP devices or the first non-3GPP device to a connectivity group identifier (CGI).

In an implementation, the method further comprises at least one of: providing differentiated QoS to the set of non-3GPP devices in the first PDU session; or providing differentiated QoS to the set of non-3GPP devices across a set of PDU sessions.

In an implementation, the first non-3GPP device does not perform non-access stratum (NAS) signaling with the core network.

In an implementation, the first non-3GPP device is connected by at least one of: a wireline connection or a wireless connection.

In various implementations of the present disclosure, an apparatus is provided. The apparatus comprises a memory, a transceiver, and a processor. The transceiver and the processor are configured to connect to a first non-3GPP device. The transceiver and the processor are further configured to receive a request for differentiated QoS associated with the first non-3GPP device. The transceiver and the processor are further configured to bind, based on the request for differentiated QoS, a first non-3GPP device identifier to the first non-3GPP device. The transceiver and the processor are further configured to transmit, to a core network, at least one of: a PDU session modification request or a PDU session establishment request. The transceiver and the processor are further configured to map a traffic stream associated with the first non-3GPP device to a first PDU session. The first PDU session is established based on at least one of: the PDU session modification request or the PDU session establishment request. The transceiver and the processor are further configured to map the traffic stream to a first QFI indicative of differentiated QoS.

In an implementation, the apparatus is a RG.

In an implementation, the request for differentiated QoS is received from one or more of: an operator portal hosted in the RG, or an AF external to the RG.

In an implementation, the first non-3GPP device identifier is provisioned by the AF.

In an implementation, at least one of: the PDU session modification request or the PDU session establishment request includes the first non-3GPP device identifier.

In an implementation, the PDU session modification request is indicative of modifying a default QFI to the first QFI for providing differentiated QoS in the first PDU session.

In an implementation, the transceiver and the processor are further configured to connect to a set of non-3GPP devices. The transceiver and the processor are further configured to receive, a set of requests for differentiated QoS associated with a set of non-3GPP devices. The transceiver and the processor are further configured to bind, based on the set of requests, a set of non-3GPP device identifiers to the set of non-3GPP devices. The transceiver and the processor are further configured to map, based on the set of requests, the set of traffic streams to a set of QFIs indicative of differentiated QoS.

In an implementation, the transceiver and the processor are further configured to at least one of: provide differentiated QoS to the set of non-3GPP devices in the first PDU session, or provide differentiated QoS to the set of non-3GPP devices across a set of PDU sessions.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and 5G core (5GC);

FIG. 4 illustrates an example of a protocol stack for a user plane and a control plane;

FIG. 5 is a flow diagram illustrating an example process for differentiated quality of service (QoS) for one or more non-third generation partnership project (3GPP) devices according to one or more embodiments;

FIG. 6A and FIG. 6B are a flow diagram illustrating an example process for provisioning of non-3GPP device information according to one or more embodiments;

FIG. 7 is a flow diagram illustrating an example process performed by a fifth generation residential gateway (5G-RG) to initiate a protocol data unit (PDU) session according to one or more embodiments;

FIG. 8 is a flow diagram illustrating an example process performed by a 5G-RG for establishing a PDU session for a category of non-3GPP devices according to one or more embodiments;

FIG. 9 is a flow diagram illustrating an example process for PDU session establishment according to one or more embodiments;

FIG. 10 is a flow diagram illustrating an example process for a session management function (SMF) initiated PDU session modification for a non-3GPP device category according to one or more embodiments;

FIG. 11 is a flow diagram illustrating an example process for providing differentiated service for one or more non-3GPP devices connected behind a 5G-RG according to one or more embodiments;

FIG. 12 is an example diagram of an overall architecture according to one or more embodiments;

FIG. 13 is a flow diagram illustrating an example process for provisioning of non-3GPP device information according to one or more embodiments;

FIG. 14 is a flow diagram illustrating an example process for provisioning of differentiated services to one or more non-3GPP devices according to one or more embodiments;

FIG. 15 is a flow diagram illustrating an example process for differentiated QoS according to one or more embodiments;

FIG. 16 is a flow diagram illustrating an example process for PDU session modification according to one or more embodiments;

FIG. 17 is a flow diagram illustrating an example process performed by a 5G-RG to establish a QoS flow for a category of one or more non-3GPP devices according to one or more embodiments;

FIG. 18 is a flow diagram illustrating an example process for network managed QoS policy according to one or more embodiments;

FIG. 19A and FIG. 19B are a flow diagram illustrating an example process for provisioning non-3GPP device information according to one or more embodiments;

FIG. 20 is a schematic diagram illustrating an example mapping of traffic from one or more individual non-3GPP devices behind a 5G-RG to a PDU session according to one or more embodiments;

FIG. 21 is a flow diagram illustrating an example process for enabling QoS differentiation for one or more individual non-3GPP devices behind the 5G-RG according to one or more embodiments; and

FIG. 22 is a flowchart illustrating a process for providing differentiated QoS to a non-3GPP device according to one or more embodiments.

### DETAILED DESCRIPTION OF THE PREFERRED EMBODIMENTS

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

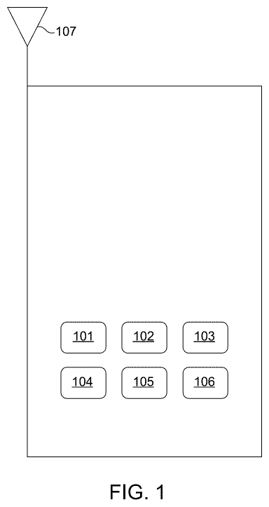

FIG. 1 is an illustration of an example device. In one case, the device may be a User Equipment (UE) suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous (e.g., different timing/spacing for UL or DL).

Different radio access technologies may be used with one or more transceivers (e.g., 802.11, WCDMA, CDMA2000, GSM, LTE, LTE-A, LTE-A Pro, NR etc.).

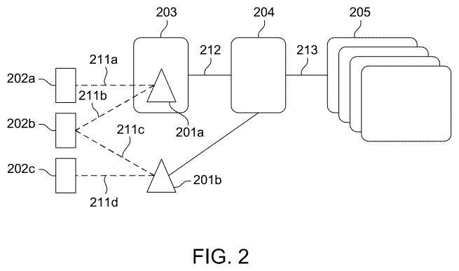

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network 206, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same RAT as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMF, one or more UPF, one or more Session Management Function (SMF), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

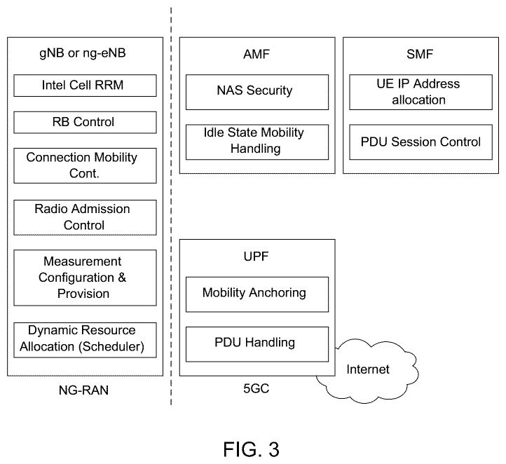

FIG. 3 illustrates an example of a functional split between the NG-RAN and 5GC. The AMF may be connected to one or more gNB the RAN via an N2 interface and may serve as a control node. For example, the AMF may be responsible for authenticating a support of the UE for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

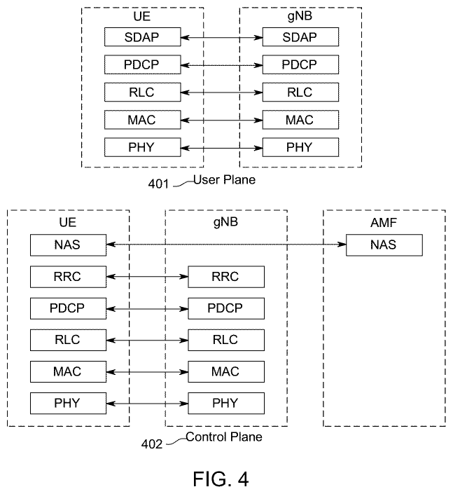

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

In various implementations of the present disclosure, based on identification, a third party and/or operator portal may be used to register various quality of service (QoS) policies for various devices. Examples of the QoS policies include but are not limited to parental control configuration, data rate characteristics, and/or application specific parameters etc.

In various techniques provided by the present disclosure, a fifth generation core network (5GC) identifies individual non-third generation partnership project (non-3GPP) devices connected behind a user equipment (UE) and/or a 5G residential gateway (5G-RG). In various techniques provided by the present disclosure, the 5GC provides policy control for traffic associated with individual non-3GPP devices. The 5G-RG may be pre-configured with and/or may receive one or more QoS policies from 3^{rd} party policy provider and/or from an auto-configuration server (ACS) and/or from a network for one or more non-3GPP devices. The QoS policy for each non-3GPP device may include one or more of: one or more QoS parameters for the non-3GPP device (e.g., bit rate requirements), service set identifier (SSID), and/or connectivity group where the non-3GPP device is associated and/or is applied with the QoS policy, and/or a device Identifier (device ID).

In various implementations of the present disclosure, various techniques are provided for identifying the one or more non-3GPP devices connected behind the UE and/or the RG (e.g., the 5G-RG). In that, an identifier may be used by the network to control and/or identify the traffic to/from the UE and/or the RG (e.g., the 5G-RG) when the traffic is associated with the one or more non-3GPP devices. In an example, the one or more non-3GPP devices use a subscription of the UE and/or the RG (e.g., the 5G-RG) to access the 5GC (i.e., the UE and/or the 5G-RG may maintain a non-access stratum (NAS) context itself and not for each non-3GPP device). Also, it may be possible for the one or more non-3GPP devices to share a protocol data unit (PDU) session.

In an implementation, the 5GC identifies the one or more individual non-3GPP devices connected behind the UE and/or the RG (e.g., 5G-RG), provides policy control for the one or more individual non-3GPP devices connected behind the UE and/or the RG (e.g., the 5G-RG) including whether and/or how to trigger the policy control for the one or more individual non-3GPP devices via policy control function (PCF) and network exposure function (NEF) application programming interfaces (APIs).

In an implementation, various techniques to provide policy control for the one or more individual non-3GPP devices behind the UE and/or the 5G-RG are provided. The 5GC may have information on the QoS policy applied to a non-3GPP device behind the 5G-RG and/or the UE where a user identifier is used between the 5GC and the 5G-RG and/or the UE to identify the QoS policy and map the QoS policy to a non-3GPP access between the non-3GPP device and the 5G-RG and/or the UE. The 5GC may store the QoS policy based on a network exposure with an external operator portal and/or application function (AF).

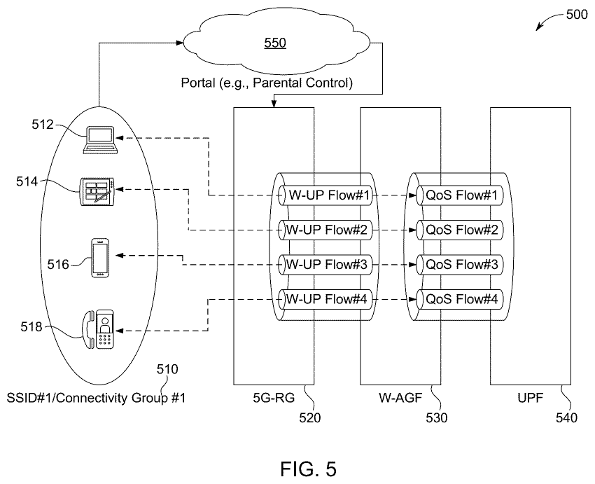

Referring now to FIG. 5, a flow diagram illustrating an example process for differentiated QoS for each non-3GPP device is shown according to one or more embodiments. As shown in FIG. 5, a plurality of devices 510 are in communication with a 5G-RG 520. The 5G-RG 520 is in communication with a wireline access gateway function (W-AGF) 530, a user plane function (UPF) 540, and a portal 550. The plurality of devices 510 include a first device 512, a second device 514, a third device 516, and a fourth device 518. One or more of the first through fourth devices 512-518 may be the one or more non-3GPP devices.

The non-3GPP devices behind 5G-RG based may be handled based on one or more connectivity group IDs. A connectivity group ID may be applied based on an SSID and/or an Ethernet port. In an example, there may be a few SSIDs available (e.g., SSID #1 for home devices and/or SSID #2 for guest devices etc.), thereby leading to certain limitations in one or more features related to providing different QoS and/or parental controls over the first through fourth devices 512-518 sharing a same SSID. To provide differentiated QoS provisioning for the one or more non-3GPP devices of the first through fourth devices 512-518 behind the 5G-RG 520 and/or the UE, the 5G-RG 520 and/or UE may identify each individual non-3GPP device and the 5GC may provision separately for each individual non-3GPP device. To allow separate provisioning by the 5GC for each non-3GPP device, a user identifier is necessary for each non-3GPP device. In an example, the user identifier may be different from a media access control (MAC) address of the non-3GPP device. In an example, a randomized MAC addresses may be used, namely, a device ID and an identifiable random MAC address (IRM). In that, using the device ID mechanism, the 5G-RG and/or the UE may provide the identifier to a non-3GPP device that may be used by the non-3GPP device where the device ID is constant in the extended service set (ESS) regardless of the MAC address used by the non-3GPP device. Further, using the IRM, the non-3GPP device may provide the random MAC address to the 5G-RG and/or the UE where the IRM MAC address may be used as transmitted address. In an example, when the device ID mechanism is used, the device ID may be used as the user identifier of the non-3GPP device. When the IRM is used, the operator may assign the user identifier of the non-3GPP device that is associated with the current IRM address and is updated by the 5G-RG and/or the UE when changes occur. Another example of the user identifier is based on one or more extensible authentication protocol (EAP) credentials if the non-3GPP device supports the EAP authentication, where the EAP authentication may be performed outside of the 5GC. The user identifier known to the 5G-RG and/or the UE may be mapped to the local non-3GPP device information (e.g., device ID and/or current MAC address by 802.11bh, and/or credentials used in a wireless local area network (WLAN)) by the 5G-RG and/or the UE. In an example, the 5G-RG may be pre-configured with and/or may receive the QoS policy from the 5GC for the non-3GPP devices. The QoS policy for each non-3GPP device may include one or more QoS parameters for the non-3GPP device (e.g., bit rate requirements) and the user identifier. Based on the non-3GPP device identification by the 5G-RG and/or the UE, a separate QoS flow may be configured for each non-3GPP device. Based on a feature of the connectivity group IDs, a group of non-3GPP devices may share a same connectivity group e.g., based on the SSID. The 5G-RG may establish a separate PDU session for each connectivity group. Each non-3GPP device in each connectivity group may be further differentiated based on separate QoS flow.

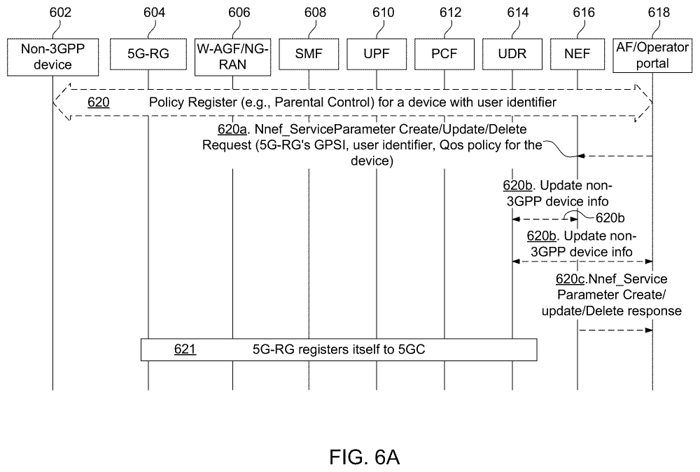

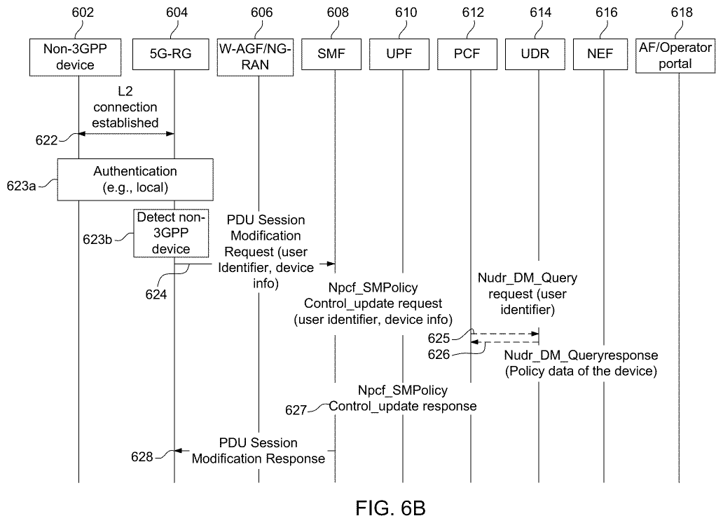

Referring now to FIG. 6A and FIG. 6B, a flow diagram illustrating an example process for the provisioning of non-3GPP device information is shown according to one or more embodiments. The process is performed by a non-3GPP device 602, a 5G-RG 604, a W-AGF/NG-RAN 606, a SMF 608, a UPF 610, a PCF 612, a UDR 614, a NEF 616, and an AF/operator portal 618.

At 620, a policy for a non-3GPP device may be registered to the AF/operator portal 618 (e.g., via the AF, the register parental control for tablets etc.). During the policy registration, the user identifier of the non-3GPP device may be determined (e.g., either by assigning by AF/operator portal 618 and/or the 5G-RG 604 provides the user identifier) and stored in the 5G-RG 604 associated with the non-3GPP device 602. For example, based on the device ID technique, the non-3GPP device 602 and the 5G-RG 604 may use the device ID which maps to the user identifier in the AF/operator portal 618 for future communications. In case the IRM is used, the 5G-RG 604 may maintain a random MAC address to the user identifier so that when the non-3GPP device 602 uses a random MAC address, the 5G-RG 604 identifies the non-3GPP device 602 and maps the non-3GPP device 602 to the user identifier. The 5G-RG 604 information would be known to the AF/operator portal 618 (e.g., 5G-RG generic public subscription identifier (GPSI) is known to the operator portal).

At 620a, 620b, and 620c, upon creating a policy for the non-3GPP device 602, the AF/operator portal 618 updates the policy associated with the 5G-RG 604 based on the policy configuration via NEF procedure (e.g., extending service specific parameter procedure for non-3GPP policy information etc.). If AF/operator portal 618 is trusted or within the PLMN domain, AF/operator portal 618 may directly communicate with the PCF 612 without the NEF 616. This step may be optional such that the UDR 614 may not maintain policy information for the non-3GPP device 602.

At 621, the 5G-RG 604 registers to the 5GC. At 622, the non-3GPP device 602 establishes an L2 connection (e.g., a WLAN connection) to the 5G-RG 604. At 623, the non-3GPP device 602 is authenticated via local authentication (e.g., pre-shared key (PSK)). The non-3GPP device 602 may be authenticated using EAP authentication via external EAP-server depending on the device capability. At 622 and 623, the 5G-RG 604 maps the non-3GPP local information (e.g., the current MAC address) to the user identifier. The 5G-RG 604 detects the non-3GPP device 602 using the user identifier. At 624-628, a PDU session modification procedure is performed. The user identifier and the device information (such as but not limited to the IP address of the device) may be used to apply appropriate QoS flow to the non-3GPP device 602. In an example, one or more extensions to an NEF service parameter service may be provided to allow the AF to provision the non-3GPP device information. In an example, one or more extensions to application data in the UDR may be provided to store the non-3GPP device information (e.g., the user identifier, policy for the non-3GPP device etc.). In an example, the PCF may retrieve the non-3GPP device information from the UDR and take the non-3GPP device information into account for policy decisions.

In various implementations, differentiated service for the non-3GPP devices connected behind the 5G-RG is provided. In an implementation, the 5G-RG may receive one or more QoS rules for the non-3GPP devices behind the 5G-RG. Then the 5G-RG may use a corresponding data transfer tunnel to transfer the packets associated with the non-3GPP devices according to the QoS rules. In an example, the implementation may be used for one or more non-authenticable non-3GPP (NAUN3) devices. The 5G-RG may be pre-configured and/or may receive a session policy for the non-3GPP devices from the network during a PDU session establishment procedure. The session policy for the non-3GPP devices may describe one or more of the following information: information regarding establishing a QoS flow for one category of non-3GPP devices, a data network name (DNN) and/or single network slice selection assistance information (S-NSSAI) corresponding to the PDU session of the QoS flow for the non-3GPP devices, the non-3GPP device category identifier (the non-3GPP device category identifier may be used to identify one or a group of non-3GPP devices, the non-3GPP device category identifier may be a standardized value, e.g. 5QI etc.), a mapping relationship between the non-3GPP device category identifier and a corresponding port number range used for one or more packets of the non-3GPP device category when transferred in the 5GS. When the 5G-RG detects the connection of the non-3GPP device, the 5G-RG may request to establish the QoS flow for the non-3GPP device according to the session policy. If there is already a corresponding PDU session (i.e. one or more PDU sessions with the same DNN and/or S-NSSAI etc.), the 5G-RG may perform the PDU session modification procedure. If there is no corresponding PDU session (i.e., no PDU sessions with the same DNN and/or S-NSSAI etc.), the 5G-RG may perform the PDU session establishment procedure.

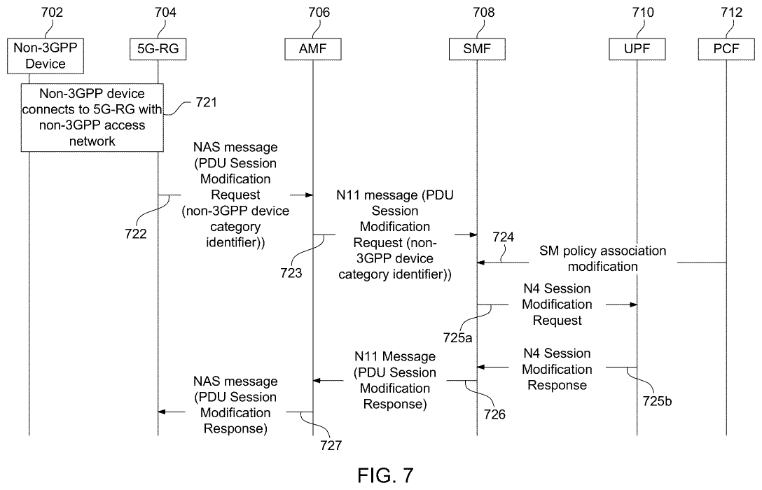

Referring now to FIG. 7, a flow diagram illustrating an example process performed by a 5G-RG to initiate a PDU session 3GPP device category and establish a QoS flow for one or more category of non-3GPP devices is shown according to one or more embodiments. The process is performed by a non-3GPP device 702, a 5G-RG 704, an AMF 706, an SMF 708, a UPF 710, and a PCF 712.

At 721, the non-3GPP device 702 connects to the 5G-RG 704 with the non-3GPP access network (e.g. establishes WiFi association etc.). During this procedure, the 5G-RG 704 may obtain the non-3GPP device category identifier. The 5G-RG 704 may map the WLAN SSID and/or physical Ethernet port identifier used by the non-3GPP device 702 to the non-3GPP device category identifier. The 5G-RG 704 may perform such mapping based on local configuration. The 5G-RG 704 may be configured (e.g. by a device vendor) with a mapping relationship between the WLAN SSID and/or a physical Ethernet port identifier used by the non-3GPP device 702 to the non-3GPP device category identifier. When the 5G-RG 704 receives one or more uplink (UL) packets of a non-3GPP device in this category, the 5G-RG 704 modifies a source port number of a packet to one of the port numbers in the port number range. When the 5G-RG 704 receives one or more downlink (DL) packets of the non-3GPP device 702 in this category, the 5G-RG 704 modifies a destination port number of a packet to the original source port number of the UL packet. The 5G-RG 704 may configure an IP address (i.e. using an IPv6 prefix delegation and/or a local IPv4 address allocation mechanism etc.) to the non-3GPP device 702.

At 722, the 5G-RG 704 may transmit a NAS message to the AMF 706. The NAS message includes a PDU session modification request, including PDU session ID, a 5G-RG ID and/or a non-3GPP device category identifier etc. Optionally, a non-3GPP indication may also be included. The 5G-RG 704 may determine to request to establish a QoS flow for the category of the non-3GPP devices according to the session policy for the non-3GPP devices. In an example, the 5G-RG may have already established a PDU session.

At 723, the AMF 706 may transmit an N11 message to the SMF 708 and forward the PDU session modification request.

At 724, the SMF 708 may report the non-3GPP device category identifier to the PCF 712 by initiating an SM association modification procedure. The PCF 712 may provide the one or more QoS rules for the category of the non-3GPP devices to the SMF 708.

At 725a-725b, for Ethernet PDU session type, the SMF 708 may update the UPF 710 with one or more N4 rules by indicating that this PDU session is also used to transfer the traffic related to the MAC address of the non-3GPP device.

At 726, the SMF 708 may generate a PDU session modification message including the QoS rules for the non-3GPP device. The SMF 708 may transmit N11 message to the AMF 706, including the PDU session modification message, the 5G-RG ID and/or the non-3GPP device category identifier.

At 727, the AMF 706 may transmit a NAS message to the 5G-RG 704, forwarding the PDU session modification message to the 5G-RG 704. The 5G-RG 704 may map the traffic of the non-3GPP device 702 to the QoS flow of the PDU session according to the received QoS rule. When the 5G-RG 704 detects disconnection of the non-3GPP device 702, if there is no traffic of other non-3GPP devices mapping to the QoS flow, the 5G-RG 704 initiates a PDU session modification procedure to release such QoS flow.

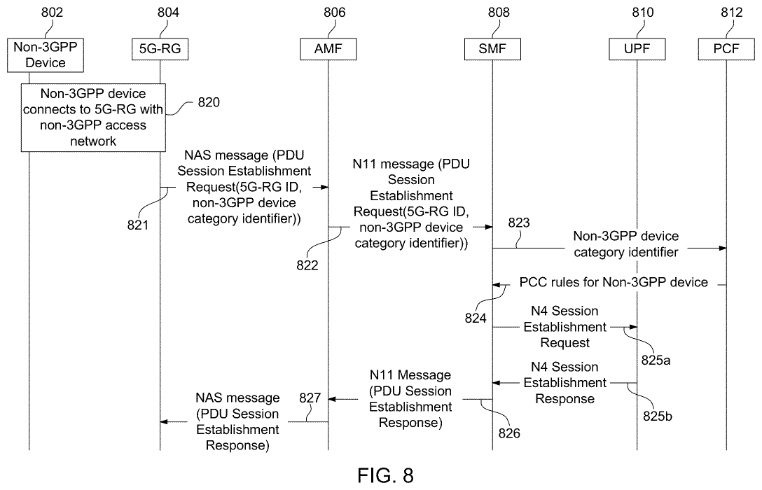

Referring now to FIG. 8, a flow diagram illustrating an example process performed by a 5G-RG for establishing a PDU session for a category of non-3GPP devices is shown according to one or more embodiments. The process is performed by a non-3GPP device 802, a 5G-RG 804, an AMF 806, an SMF 808, a UPF 810, and a PCF 812.

At 820, if the 5G-RG 804 determines to establish a PDU session for the non-3GPP device 802 according to the session policy for non-3GPP devices, the 5G-RG 804 performs a PDU session establishment procedure.

In the PDU session establishment procedure, at 821, the 5G-RG 804 includes the 5G-RG ID and non-3GPP device category identifier in the PDU session establishment request.

At 822, the AMF 806 transmits an N11 message to the SMF 808 for PDU session establishment. During SM policy association establishment procedure, in step 823, the SMF 808 reports the non-3GPP device category identifier to the PCF 812, and at 824, the PCF 812 transmits a PCC policy corresponding to the non-3GPP device category identifier.

At 825a-825b, the SMF 808 transmits the corresponding port number range used for the packets of the non-3GPP device category when transferred in the 5GS to the UPF 810. Then the UPF 810 may monitor the packets transferred in the PDU session.

At 826 and 827, the SMF 808 includes the non-3GPP device category identifier and QoS rule of the non-3GPP device 802 in the PDU session establishment response. The 5G-RG 804 maps the traffic of the non-3GPP device to the PDU session according to the received QoS rule.

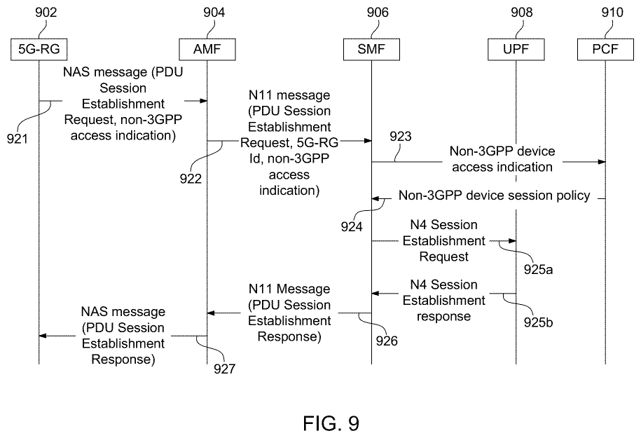

Referring now to FIG. 9, a flow diagram illustrating an example process for PDU session establishment is shown according to one or more embodiments. The process is performed by a 5G-RG 902, an AMF 904, an SMF 906, a UPF 908, and a PCF 910.

The 5G-RG 902 receives a session policy for the non-3GPP devices in the PDU session establishment procedure. The 5G-RG 902 receives the session policy for non-3GPP devices during its own PDU session establishment procedure. The 5G-RG 902 performs the PDU session establishment procedure.

At 921, the 5G-RG 902 includes a non-3GPP access indication in the PDU session establishment request to request the session policy for the non-3GPP devices behind the 5G-RG 902.

At 922, the AMF 904 transmits an N11 message to the SMF 906 for the PDU session establishment.

At 923, the SMF 906 transmits the non-3GPP access indication to the PCF 910. During the SM policy association establishment procedure, at 923, the SMF 906 reports the non-3GPP access indication to the PCF 910.

At 924, the PCF 910 transmits a session policy for the non-3GPP devices to the SMF 906.

At 925a-925b, the SMF 906 transmits the corresponding port number range used for the packets of the non-3GPP device category which are transferred in the PDU session to the UPF 908. Then the UPF 908 may monitor the packets transferred in the PDU session, e.g. drop the packet which is transferred via the PDU session but does not belong to the non-3GPP device category.

At 926-927, the SMF 906 transmits the session policy for the non-3GPP devices to the UE in the PDU session establishment response. The mapping relationship between the non-3GPP device category identifier and the corresponding port number range used for the packets of the non-3GPP device category when transferred in the 5GS is transferred to the 5G-RG 902 during PDU session establishment procedure.

In an example, other parameters in the session policy may be transferred via a URSP to establish a QoS flow for one category of non-3GPP devices, the DNN/S-NSSAI corresponding to the PDU session of the QoS flow for non-3GPP devices, and/or the non-3GPP device category identifier.

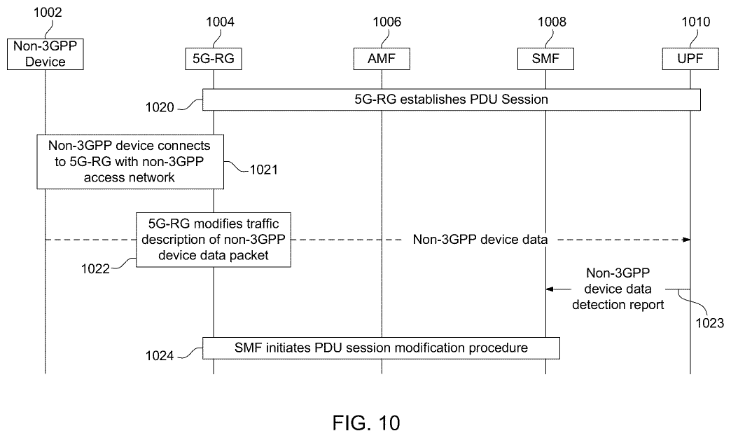

Referring now to FIG. 10, a flow diagram illustrating an example process for an SMF initiated PDU session modification for a non-3GPP device category is shown according to one or more embodiments. The process is performed by a non-3GPP device 1002, a 5G-RG 1004, an AMF 1006, an SMF 1008, and a UPF 1010.

At 1020, the 5G-RG 10004 establishes a PDU session.

At 1021, the non-3GPP device 1002 connects to the 5G-RG 1004 with non-3GPP access network (e.g. establishes WiFi association). During this procedure, the 5G-RG 1004 obtains the non-3GPP device category identifier. The 5G-RG 1004 may map the WLAN SSID and/or physical Ethernet port identifier used by the non-3GPP device to non-3GPP device category identifier. The 5G-RG 1004 may be configured (e.g. by the device vendor) with the mapping relationship between WLAN SSID or the physical Ethernet port identifier used by the non-3GPP device 1002 to the non-3GPP device category identifier.

At 1022, when 5G-RG 1004 receives UL packets of the non-3GPP device 1002 in this category, the 5G-RG 1004 modifies the source port number of the packet to one of the port numbers in the port number range. When the 5G-RG 1004 receives the DL packets of the non-3GPP device 1002 in this category, the 5G-RG 1004 modifies the destination port number of the packet to the original source port number of the UL packet.

At 1023, when the UPF 1010 detects the packets of the non-3GPP device category, the UPF 1010 reports to the SMF 1008 using the usage report.

At 1024, the SMF 1008 initiates the PDU session modification procedure to establish a QoS flow for the non-3GPP device category.

In an example, the 5G-RG requests for the QoS rule associated with the non-3GPP device behind the 5G-RG, by sending a PDU session modification message to the network and receives the requested information from the network. The 5G-RG receives the session policy for non-3GPP devices from the network and requests to establish the PDU session and/or the QoS flow based on the session policy for non-3GPP devices. The 5G-RG includes the non-3GPP access indication in the PDU session establishment request to request the session policy for non-3GPP devices behind the 5G-RG. The 5G-RG maps the MAC address, WLAN SSID and/or physical Ethernet port identifier used by the non-3GPP device to the non-3GPP device category identifier based on local configuration. The 5G-RG may be configured with the mapping relationship between the non-3GPP device category identifier and the corresponding port number range used for the packets of the non-3GPP device category when transferred in the 5GS, and the 5G-RG may modify the packets associated with the non-3GPP device category correspondingly.

In an example, the SMF requests the QoS rule for the non-3GPP device from the PCF. The SMF transmits the non-3GPP access indication to the PCF and receives the session policy for non-3GPP devices. The SMF transmits the session policy for non-3GPP devices to the UE in PDU session establishment response. The SMF transmits the corresponding port number range used for the packets of the non-3GPP device category when transferred in the 5GS to the UPF. Upon receiving the report of detection of packets associated with the non-3GPP device category, the SMF initiates the PDU session modification to establish a QoS flow for this non-3GPP device category.

In an example, the PCF provides the QoS rules for non-3GPP devices. The PCF provides session policy for non-3GPP devices to the SMF.

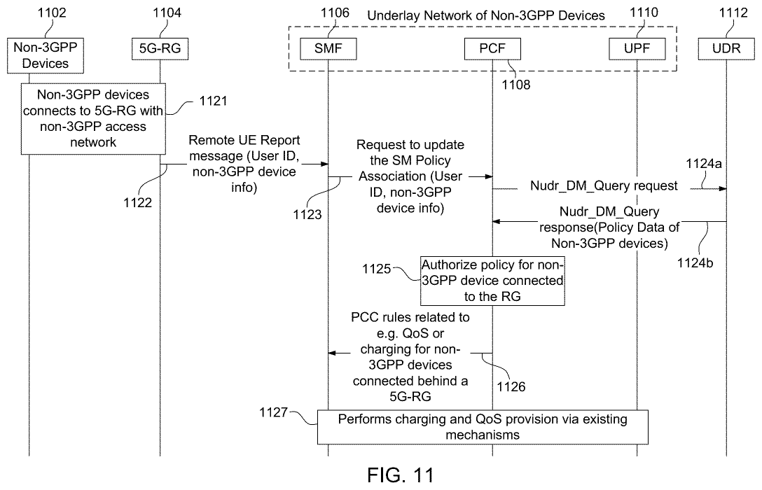

Referring now to FIG. 11, a flow diagram illustrating an example process for providing differentiated service for non-3GPP devices connected behind a 5G-RG is shown according to one or more embodiments. The process is performed by a non-3GPP device 1102, a 5G-RG 1104, an SMF 1106, a PCF 1108, a UPF 1110, and a UDR 1112.

At 1121, the non-3GPP device 1102 connects to the 5G-RG 1104 with non-3GPP access network (e.g., establishes WiFi association). During this procedure, the 5G-RG 1104 obtains the user ID of the non-3GPP device 1102 and the non-3GPP device information. The user ID is an identity of the non-3GPP device (e.g. MAC address, or a subscriber concealed identifier (SUCI) which may be acquired by an authentication procedure for non-seamless WLAN offload function (NSWOF). To acquire the SUCI and/or a subscription permanent identifier (SUPI) of the non-3GPP device 1102, the non-3GPP device 1002 and the 5G-RG 1104 may support the 5G NSWO where the 5G-RG 1104 functions as a WLAN AN. In the case of acquiring the SUPI of the non-3GPP device 1102, during the authentication procedure for NSWOF, the 5G-RG 1104 may add an indication in a protocol message to the NSWOF and an indication in Nausf_UEAuthentication_Authenticate request to an authentication server function (AUSF) for acquiring the SUPI. The AUSF may transmit the SUPI as a new parameter in Nausf_UEAuthentication_Authenticate response to NSWOF and deliver the SUPI as a new parameter in a protocol message to the 5G-RG 1104. The non-3GPP device information is used to assist identifying the non-3GPP device 1102 in the 5GC. For IP PDU session type, the non-3GPP device information is the non-3GPP device IP information, e.g. transmission control protocol (TCP) and/or user datagram protocol (UDP) port ranges assigned to the non-3GPP device 1102 by the 5G-RG 1104 as NAT in case of IPV4. For Ethernet PDU session type, the non-3GPP device information is the non-3GPP device Ethernet address.

At 1122, the 5G-RG 1104 transmits a remote UE report message to the SMF 1106 through the AMF. The remote UE report message includes the user ID of the non-3GPP device 1102 and the non-3GPP device information. In an example, the 5G-RG 1104 already establishes the PDU session to simplify the procedures.

At 1123, the SMF 1106 transmits the User ID of the non-3GPP device 1102 and the non-3GPP device information to the PCF 1108 by initiating the SM association modification procedure. The SMF 1106 may store the User ID of the Non-3GPP device 1102 and the non-3GPP device information. Then SMF 1106 may retrieve subscription data for the non-3GPP device 1102 from the UDM using Nudm_SDM_Get service.

At 1124a-1124b, the PCF stores the user ID of the non-3GPP device 1102 and the non-3GPP device information. The PCF 1108 may retrieve the policy information for the non-3GPP device from a local configuration (e.g. common policy for Non-3GPP device) or from the UDR using Nudr_DM_Query service.

At 1125, the PCF 1108 may authorize the policy for the non-3GPP device 1102 based on the policy information at 1124.

At 1126, the PCF 1108 generates and transmits the PCC rules related to e.g. QoS or charging for non-3GPP devices connected behind the 5G-RG.

At 1127, the SMF 1106 performs charging and QoS provision for the data traffic of the non-3GPP device via existing mechanisms and the SMF 1106 provides the charging information with the corresponding user ID to a charging function (CHF). The CHF session may deal with the 5G RG traffic and with the traffic of different devices behind the 5G RG e.g. distinguish different traffic by the corresponding user ID.

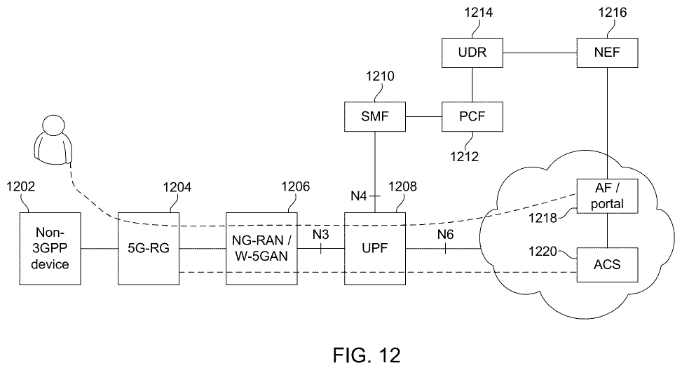

Referring now to FIG. 12, an example diagram of an overall architecture is shown according to one or more embodiments. The overall architecture includes a non-3GPP device 1202, a 5G-RG 1204, a NG-RAN/W-5GAN 1206, a UPF 1208, an SMF 1210, a PCF 1212, a UDR 1214, a NEF 1216, an AF/portal 1218, an ACS 1220.

In an implementation, the architecture provides differentiated services (e.g. QoS and charging) for non-3GPP devices behind a 5G-RG. The architecture includes three parts that are used to provide the differentiated services: an example for how the non-3GPP device information may be created in an AF, one or more enhancements to the NEF exposure services to provide the non-3GPP device information to the 5GC, and a description for how the traffic from the non-3GPP devices may be identified in the 5GC to provide differentiated charging and QoS.

For providing non-3GPP device information to the AF, the AF may have access to the information about the non-3GPP devices that are and/or have been connected behind the RG. The ACS may retrieve the information about the non-3GPP devices from the 5G-RG. This information may, for example, contain the host table from the DHCP server in the RG, or device list gathered by other means, and typically includes for each device: a host name, the MAC address of the device and/or the IP address allocated to the device.

In case of IPv4 traffic, the routed RG typically has NAT functionality. The IPv4 addresses in the list of non-3GPP devices received from the RG would thus correspond to one or more private IPv4 addresses. The private addresses may not be useful for traffic detection in the 5GC. In this case, the NAT in the 5G-RG may assign a port range for each device and may provide the external IP address and the port range associated with each device to the ACS. The non-3GPP device information is then provided from the ACS to the AF.

In an example, an operator may integrate a web portal with the AF. An end-user (e.g. a person that owns the subscription for the RG) may login to the web portal and manage a list of devices. The end-user could, for example, select a device profile for each device from a drop-down menu. The device profile may, for example, indicate a type of non-3GPP device (set top box, printer, tablet, and/or PC etc.), or be a reference to a QoS category. How the device profile ID may be interpreted as per an operator configuration.

In an example, the AF may include a table comprising a list of non-3GPP devices in the network (e.g., home). The table may include a host name (which may be informative but is not guaranteed to be unique), MAC address, assigned IPv4 address (local to the home LAN) and IPv6 address. The combination of host name and MAC address may be a unique and/or persistent identification of a specific device connected to the network, for example, a home LAN etc.

In an example, the AF may be directed by an authorized subscriber to request differentiated service for one or more devices in the list of non-3GPP devices of the AF. For provisioning of the non-3GPP device information to the 5GC, an existing NEF service parameter service may be enhanced with a new service description to allow the AF to provide the non-3GPP device information to the 5GC. The information may be used by the 5GC to detect the traffic to and/or from a non-3GPP device and also to provide differentiated QoS and/or charging.

The information provided by the AF via the Nef_ServiceParameter service includes but is not limited to GPSI of the RG, a list of non-3GPP devices, including for each device: IPv6 address or IPv4 and the port number of the device, and/or device profile ID etc. The NEF maps the GPSI of the RG to the SUPI of the RG and stores the non-3GPP device information in the UDR as application data.

For differentiated services per non-3GPP device, when the PDU session for the RG is established, the PCF contacts the UDR to subscribe to the application data that may be available The PCF thus receives the non-3GPP device information from the UDR corresponding to the SUPI of the RG. The PCF receives the service parameters as well as other information (e.g., subscribed QoS of the RG and policy subscription data in UDR of the RG) into account for policy decisions, for example, to determine QoS and charging parameters for the traffic of the non-3GPP device. The PCF may provide the PCC rules to the SMF that are specific for individual non-3GPP devices, including a service data flow (SDF) filter with the IPv6 address and/or IPv4 address and the port number of the device, and corresponding QoS and charging related parameters. The PCF may provide different PCC rules for different services, as per existing standards.

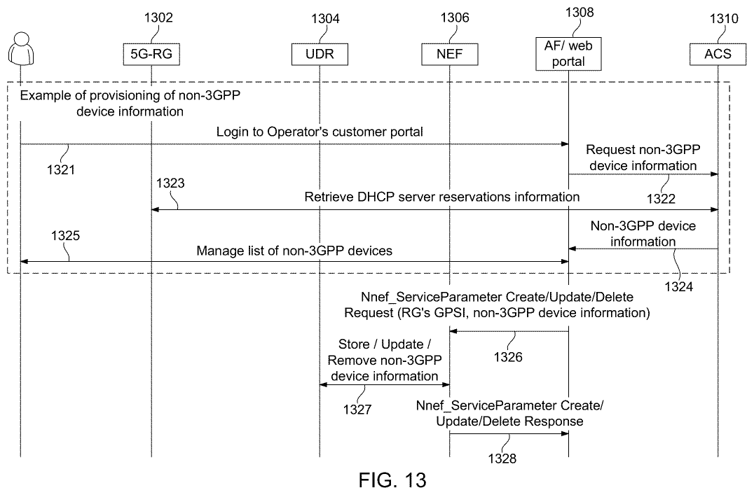

Referring now to FIG. 13, a flow diagram illustrating an example process for provisioning of the non-3GPP device information is shown according to one or more embodiments. The process of performed by a 5G-RG 1302, a UDR 1304, a NEF 1306, an AF/portal 1308, and an ACS 1310.

At 1321, 1322, 1323, 1324 and 1325, an end-user logs in to the AF/portal 1308 and manages the list of non-3GPP devices associated with the 5G-RG 1302.

At 1326, the AF/portal 1308 invokes a Nnef_ServiceParameter service to provide the non-3GPP device information for the GPSI of the RG to the NEF.

At 1327, the NEF maps the GPSI of the RG to a SUPI and stores the information in the UDR 1304.

At 1328, the NEF 1306 sends a Nnef_ServiceParameter response to the AF/portal 1308.

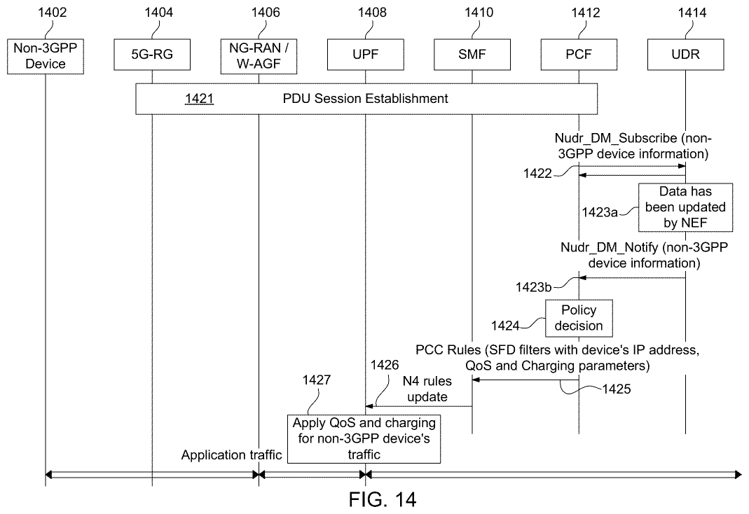

Referring now to FIG. 14, a flow diagram illustrating an example process for provisioning of differentiated services to the non-3GPP devices is shown according to one or more embodiments. The process is performed by a non-3GPP device 1402, a 5G-RG 1404, a NG-RAN/W-AGF 1406, a UPF 1408, a SMF 1410, a PCF 1412, and a UDR 1414.

At 1421, the 5G-RG 1404 establishes the PDU session.

At 1422, the PCF 1412 subscribes to the non-3GPP device information from the UDR 1414. The PCF 1412 may e.g. use the DNN to determine whether to request such data from UDR 1414.

At 1423a-1423b, in case the non-3GPP device information is updated during the lifetime of the PDU session of the 5G-RG 1404, the UDR 1414 notifies the PCF 1412 about the updated information.

At 1424, the PCF 1412 considers the non-3GPP device information for the policy decision. The non-3GPP device profile ID may map to a set of QoS parameters or charging related parameters.

At 1425, the PCF 1412 provides updated policy rules to the SMF 1410.

At 1426, the SMF 1410 initiates corresponding updates of the N4 rules.

At 1427, the UPF 1408 applies the QoS and charging for the traffic of the non-3GPP devices.

In an example, the one or more extensions to the NEF service parameter service are provided to allow the AF to provision the non-3GPP device information.

In an example, the one or more extensions to the application data in the UDR are provided to store non-3GPP device information.

In an example, the PCF is provided with the ability to retrieve the non-3GPP device information from the UDR and the non-3GPP device information considered for one or more policy decisions.

In an example, the 5G-RG may provide the list of non-3GPP devices to the ACS, with host name, MAC address and/or IP address for each device etc. For IPv4 with a NAT in the 5G-RG, the 5G-RG provides the external IP address and the associated port range for each device to the ACS.

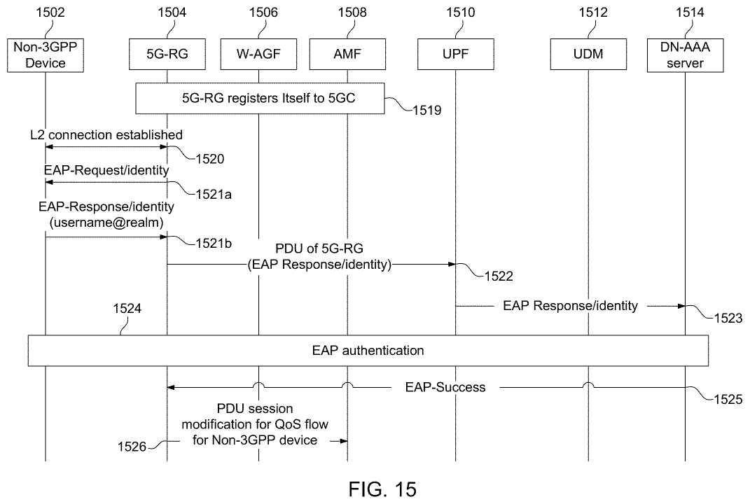

Referring now to FIG. 15, a flow chart illustrating an example process for differentiated QoS is shown according to one or more embodiments. The process is performed by a non-3GPP device 1502, a 5G-RG 1504, a W-AGF 1506, an AMF 1508, a UPF 1510, a UDM 1512, and a DN-AAA server 1514.

At 1519, the 5G-RG 1504 registers itself to the 5GC. At 1520, the non-3GPP device 1502 behind the 5G-RG 1504 establishes a L2 connection (e.g., WLAN connection). At 1520, based on a EAP mechanism, the 5G-RG 1504 may transmit EAP request and/or identity to the non-3GPP device 1502. At 1521a-1521b, the non-3GPP device 1502 may respond for the non-3GPP access. At 1522-1523, the 5G-RG 1504 may forward the EAP response and/or identity message to the DN-AAA server 1514 (or external AAA server and/or authentication server etc.). At 1524, the non-3GPP device 1502 and the DN-AAA server 1514 may perform the EAP authentication. At 1525, upon successful EAP authentication, an EAP success response is transmitted by the DN-AAA server 1514 to the 5G-RG 1504 and/or the non-3GPP device 1502. Upon receiving the EAP success and/or completing a four-way handshaking with the non-3GPP device, the 5G-RG 1504 determines that the non-3GPP device 1502 is successfully associated. The 5G-RG 1504 may be preconfigured and/or configured by the network. In an example, one or more parental control parameters for the non-3GPP device 1502 may be configured in the 5G-RG 1504. Upon detection of an entry with the device identifier matching to the non-3GPP device 1502, at 1526, if the PDU session is already established, the 5G-RG 1504 may initiate the PDU session modification for a connectivity group associated with the non-3GPP device 1502. If the PDU session is not already established, the 5G-RG 1504 may initiate the PDU session establishment for the connectivity group with the QoS configuration of the non-3GPP device 1502. The EAP framework may be used for authentication between the non-3GPP device 1502 and the DN-AAA server 1514 in the external data network. The 5G-RG 1504 shall perform the role of the EAP Authenticator

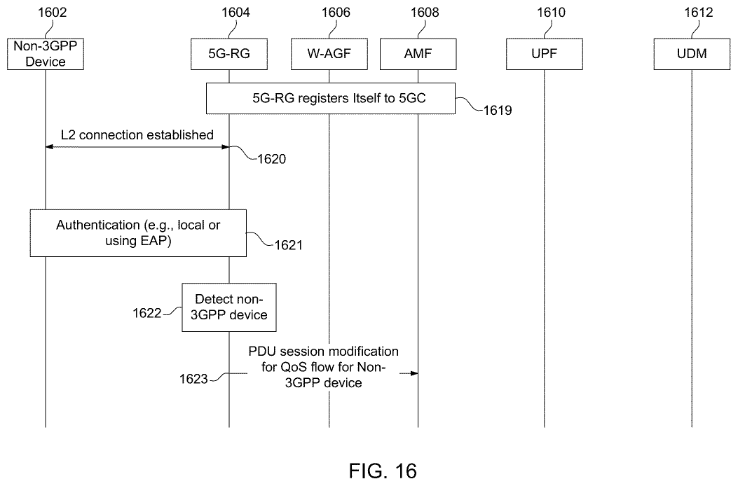

Referring now to FIG. 16, a flow diagram illustrating an example process for a PDU session modification is shown according to one or more embodiments. The process is performed by a non-3GPP device 1602, a 5G-RG 1604, a W-AGF 1606, an AMF 1608, a UPF 1610, and a UDM 1612.

At 1619, the 5G-RG 1604 may register to the 5GC.

At 1620, the L2 connection is established between the non-3GPP device 1602 and the 5G-RG 1604.

At 1621, the 5G-RG 1604 authenticates the non-3GPP device 1602.

At 1622, the 5G-RG 1604 detects the non-3GPP device 1602.

At 1623, the 5G-RG 1604 transmits the PDU session modification request to the AMF 1608.

The 5G-RG 1604 may detect the non-3GPP device 1602 in response to a local authentication with a device identification and/or an EAP mechanism. In an example, the following procedure may be used by the 5G-RG 1604 to request the PDU session modification where a non-3GPP device category identifier is replaced by a non-3GPP device identifier of a non-3GPP device.

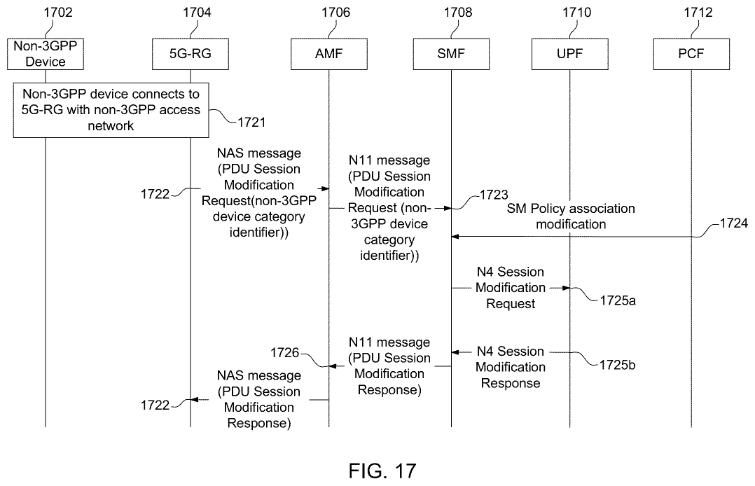

Referring now to FIG. 17, a flow diagram illustrating a process performed by a 5G-RG to establish a QoS flow for one category of non-3GPP devices is shown according to one or more embodiments. The process is performed by a non-3GPP device 1702, a 5G-RG 1704, an AMF 1706, an SMF 1708, a UPF 1710, and a PCF 1712.

At 1721, the non-3GPP device 1702 connects to the 5G-RG 1704 with non-3GPP access network (e.g. establishes WiFi association). During this procedure, the 5G-RG 1704 obtains the non-3GPP device category identifier. The 5G-RG 1704 may map the WLAN SSID and/or the physical Ethernet port identifier used by the non-3GPP device 1702 to the non-3GPP device category identifier. In an example, the 5G-RG 1704 may perform such mapping based on the local configuration. The 5G-RG 1704 may be configured (e.g. by a device vendor) with the mapping relationship between WLAN SSID and/or the physical Ethernet port identifier used by the non-3GPP device 1702 to the non-3GPP device category identifier. When the 5G-RG 1704 receives the UL packets of the non-3GPP device 1702 in this category, the 5G-RG 1704 modifies the source port number of the packet to one of the port numbers in the port number range. When the 5G-RG 1704 receives the DL packets of a non-3GPP device 1702 in this category, the 5G-RG 1704 modifies the destination port number of the packet to the original source port number of the UL packet. The 5G-RG 1704 may configure the IP address (i.e. using IPv6 prefix delegation and/or local IPv4 address allocation mechanism) to the non-3GPP device.

At 1722, the 5G-RG 1704 transmits the NAS message to the AMF 1706. The NAS message includes the PDU session modification request, including a PDU session ID, a 5G-RG ID and a non-3GPP device category identifier. Optionally, the non-3GPP indication is also included. The 5G-RG 1704 determines to request to establish the QoS flow for the category of non-3GPP devices according to the session policy for non-3GPP devices. In an example, the 5G-RG already establishes the PDU session.

At 1723, the AMF 1706 transmits the N11 message to the SMF 1708 and forwards the PDU session modification request.

At 1724, the SMF 1708 reports the non-3GPP device category identifier to the PCF 1712 by initiating the SM association modification procedure. The PCF 1712 provides QoS rules for the category of the non-3GPP devices to the SMF 1708.

At 1725a-1725b, for the Ethernet PDU session type, the SMF 1708 updates the UPF 1710 with the N4 rules by indicating that this PDU session is also used to transfer the traffic related to the MAC address of the non-3GPP device 1702.

At 1726, the SMF 1708 generates the PDU session modification message including the QoS rules for the non-3GPP device 1702. The SMF 1708 transmits the N11 message to the AMF 1706, including the PDU session modification message, the 5G-RG ID and non-3GPP device category identifier.

At 1727, the AMF 1706 transmits the NAS message to the 5G-RG 1704, forwarding the PDU session modification message to the 5G-RG 1704. The 5G-RG 1704 maps the traffic of the non-3GPP device 1702 to the QoS flow of this PDU session according to the received QoS rule.

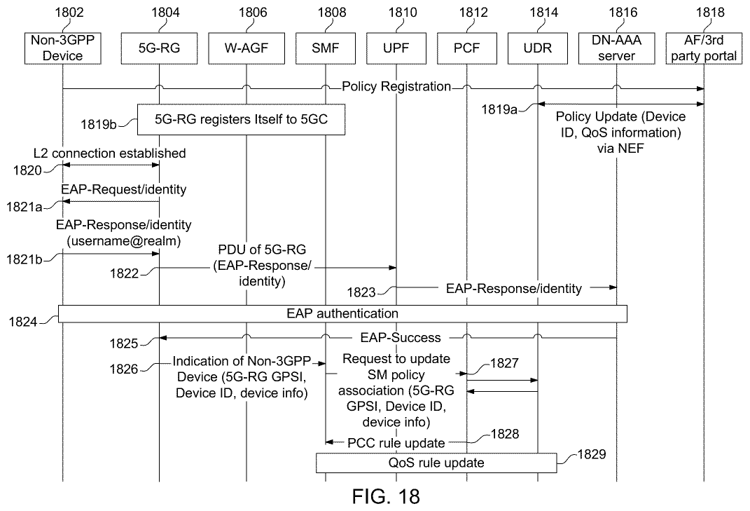

Referring now to FIG. 18, a flow diagram illustrating an example process of network managed non-3GPP behind RG QoS policy is shown according to one or more embodiments. The process is performed by a non-3GPP device 1802, a 5G-RG 1804, a W-AGF 1806, an SMF 1808, a UPF 1810, a PCF 1812, a UDR 1814, a DN-AAA server 1816, and an AF/portal 1818.

At 1819a, the AF/portal 1818 provides the policy update.

At 1819b, the 5G-RG 1804 registers itself to the 5GC.

At 1820, the non-3GPP device 1802 establishes connection with the 5G-RG 1804.

At 1821a-1821b though 1823, the non-3GPP device 1802 and the 5G-RG 1804 performs EAP request and response and forwards the EAP response to the DN-AAA server 1816.

At 1824-1825, the non-3GPP device 1802 and the DN-AAA server 1816 may perform the EAP authentication.

At 1826, the 5G-RG 1804 may transmit the indication of the non-3GPP device 1802 to the SMF 1808 via the AMF.

At 1827, the SMF 1808, in response to the indication, may request to update SM policy association. The request may include the 5G-RG ID such as the GPSI or the SUPI, and the device identifier (e.g., device ID) and device information (e.g., QoS configuration). The SMF 1808 sends the non-3GPP device identifier (e.g., device ID) and the non-3GPP device information (e.g., QoS configuration) to the PCF 1812 by initiating the SM association modification procedure. The SMF 1808 may store the non-3GPP device identifier and the non-3GPP device information.

At 1828, the SMF 1808 may retrieve the subscription data for the non-3GPP device 1802 from the UDR 1814 using the Nudm_SDM_Get service.

At 1829, the PCF 1812 stores the non-3GPP device identifier and the non-3GPP device information. The PCF 1812 may retrieve the policy information for the non-3GPP device 1802 from local configuration (e.g. common policy for the non-3GPP device 1802) or from the UDR using Nudr_DM_Query service. The PCF 1812 may authorize the policy for the non-3GPP device 1802 based on policy information.

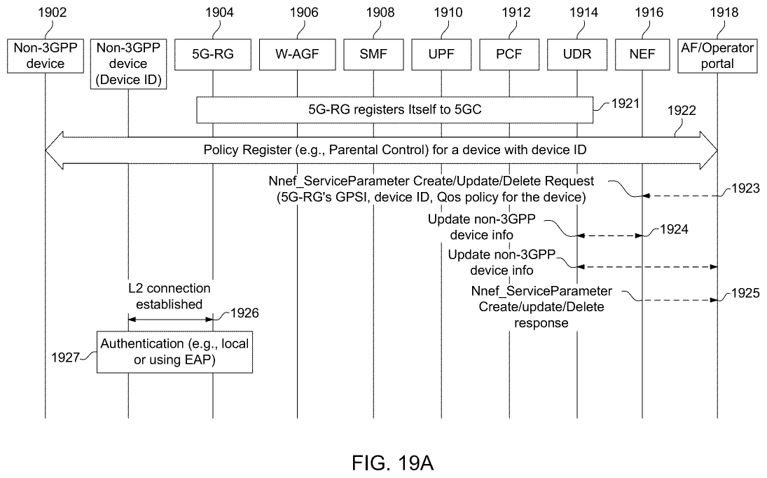

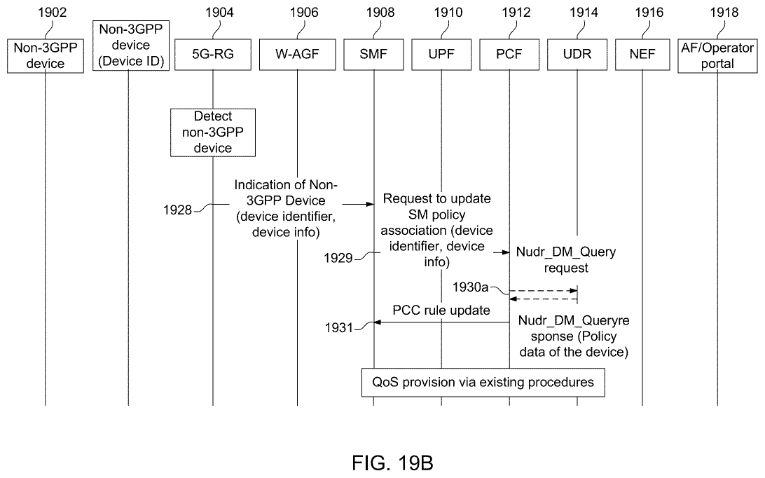

Referring now to FIG. 19A and FIG. 19B, a flow diagram illustrating an example process of provisioning of non-3GPP device information is shown according to one or more embodiments. The process is performed by a non-3GPP device 1902, a 5G-RG 1904, a W-AGF 1906, a SMF 1908, a UPF 1910, a PCF 1912, a UDR 1914, a NEF 1916, and an AF/operator portal 1918.

At 1921, the 5G-RG 1904 registers to the 5GC.

At 1922, the non-3GPP device 1902 may register the policy for a second non-3GPP device and/or for itself (e.g., parental configuration by a parent for a device belonging to kids etc.) via the AF/operator portal 1918. The device identifier of the second non-3GPP device may be used for the policy registration. For example, a device ID of the second non-3GPP device may be used and/or a device identifier assigned by the AF/operator portal 1918 may be used as the identifier.

At 1923-1925, upon creating a policy for the second non-3GPP device, the AF/operator portal 1918 updates the policy associated with the 5G-RG 1904 based on the policy configuration via the NEF procedure. If the AF/operator portal 1918 is trusted or within the PLMN domain, the AF/operator portal 1918 may directly communicate with the UPF 1910 without the NEF 1916.

At 1926, the second non-3GPP device establishes the L2 connection (e.g., WLAN connection) to the 5G-RG 1904.

At 1927, the second non-3GPP device is authenticated via local authentication (e.g., PKS) and/or via EAP via external EAP server. During the procedure, the 5G-RG 1904 identifies a device identifier of the second non-3GPP device (e.g., device ID, a identifier assigned by the operator/operator portal, EAP credential).

At 1928, the 5G-RG 1904 may transmit the indication of the non-3GPP device to SMF 1908 via AMF. The SMF 1908, in response to the indication, may request to update SM policy association. The request may include the 5G-RG ID such as GPSI and/or SUPI, and a device identifier (e.g., device ID) and/or device information (e.g., QoS configuration) etc., for example.

At 1929, the SMF 1908 transmits the non-3GPP device identifier (e.g., device ID) and the non-3GPP device information (e.g., QoS configuration) to the PCF by initiating the SM association modification procedure. The SMF 1908 may store the non-3GPP device identifier and the non-3GPP device information. Then SMF 1908 may receive the subscription data for the non-3GPP device from the UDM using the Nudm_SDM_Get service.

At 1930a-1930b, the PCF 1912 stores the non-3GPP device identifier and the non-3GPP device information. The PCF 1912 may retrieve the policy information for the non-3GPP device from the local configuration (e.g. common policy for the non-3GPP device) and/or from UDR using Nudr_DM_Query service.

At 1931, the PCF 1912 shall authorize policy for the non-3GPP device based on policy information at step the above. The SMF may perform charging and QoS provision for the data traffic of the non-3GPP device via existing mechanisms. And the SMF 1908 provides the charging information with corresponding user ID to the CHF. The same CHF session is proposed to be used to deal with the 5G RG traffic and with the traffic of different devices behind the 5G RG e.g. distinguish different traffic by corresponding user ID.

In an example, the one or more extensions to the NEF service parameter service to allow the AF to provision the non-3GPP device information. In an example, one or more extensions to the application data in the UDR are provided to store the non-3GPP device information. The PCF has the ability to retrieve the non-3GPP device information from the UDR and consider the non-3GPP device information for the policy decisions. The 5G-RG may provide the list of non-3GPP devices to the ACS, with host name, MAC address and/or IP address for each device etc. For IPv4 with a NAT in the 5G-RG, the 5G-RG may provide the external IP address and the associated port range for each device to the ACS.

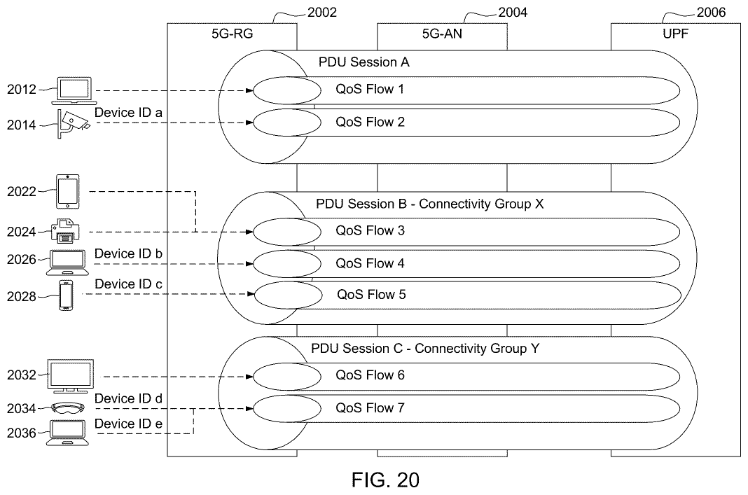

Referring now to FIG. 20, a schematic diagram illustrating an example mapping traffic of the one or more individual non-3GPP devices behind the 5G-RG to a PDU session is shown according to one or more embodiments. FIG. 20 shows a 5G-RG 2002, a 5G-AN 2004, a UPF 2006, a first set of devices 2012-2014, a second set of devices 2022-2028, and a third set of devices 2032-2036.

In various implementations, the support for identifying the traffic of individual non-3GPP devices behind the 5G-RG and providing differentiated QoS is provided. The non-3GPP devices associated with the same PDU session may be further differentiated using the corresponding non-3GPP device identifiers.

In an example, two non-3GPP devices (e.g. the first set of devices 2012-2014) mapped to PDU session A initially use a default QoS flow associated with a default QoS flow identifier (e.g., QFI 1). When a differentiated QoS is requested for one device, the 5G-RG 2002 binds its traffic to the non-3GPP device identifier, and its traffic is mapped to a separate QoS flow associated with a separate QFI (e.g., QFI 2). For four non-3GPP devices (e.g., the second set of devices 2022-2028) mapped to PDU Session B based on their connectivity group ID X initially used the default QoS flow (e.g., QFI 3); when differentiated QoS is requested for two of those four devices, the 5G-RG 2002 binds their traffic to non-3GPP device identifiers, and their traffic is mapped to separate QoS flows (e.g., QFI 4 and QFI 5). Similarly, three non-3GPP devices (e.g., the third set of devices 2032-2036) mapped to the PDU session C based on their connectivity group ID Y initially used the default QoS flow (e.g., QFI 6). When differentiated, a same QoS is requested for two of those three devices, and the 5G-RG 2002 binds the traffic from the two devices to the non-3GPP device identifiers, and their traffic is mapped to a separate QoS flow (e.g., QFI 7).

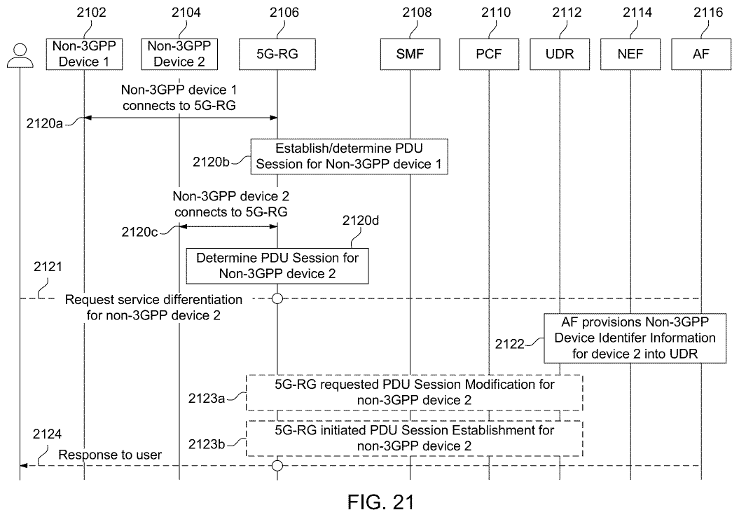

Referring now to FIG. 21, a flow diagram illustrating an example process for enabling QoS differentiation for individual non-3GPP devices behind the 5G-RG is shown according to one or more embodiments. The process is performed by a first non-3GPP device 2102, a second non-3GPP device 2104, a 5G-RG 2106, an SMF 2108, a PCF 2110, a UDR 2112, a NEF 2114, and an AF 2116.

The process enables the 5GS to identify the traffic of the individual non-3GPP devices initially using the same PDU session behind the 5G-RG 2106 and provide differentiated QoS.

At 2120a, the first non-3GPP device 2102 is connected to the 5G-RG 2106.

At 2120b, to provide connectivity to the first non-3GPP device 2102, the 5G-RG 2106 implements the existing behavior of either using the URSP rule (optionally containing the connectivity group ID), or using a UE local configuration, to map the traffic of the first non-3GPP device to a PDU session.

At 2120c, the second non-3GPP device 2104 is connected to the 5G-RG 2106.

At 2120d, to provide connectivity to the second non-3GPP device 2104, the 5G-RG 2106 uses the URSP rule (optionally containing the connectivity group ID) and/or using UE local configuration, to map the traffic of the second non-3GPP device 2104 to the same PDU session as the first non-3GPP device 2102.

At 2121, the 5G-RG subscription owner and/or an authorized user requests differentiated QoS for the second non-3GPP device 2104 through the AF 2116. The request for differentiated service may be made through an operator portal hosted either in the 5G-RG 2106 or in the AF 2116.

At 2122, the AF 2116 provisions the non-3GPP device identifier information for the second non-3GPP device 2104 into the UDR 2112. In an example, the provisioning of the non-3GPP device identifier information into the UDR 2112 is done for the non-3GPP devices that require differentiated QoS. This provisioning may be done before a device is connected to the 5G-RG 2106.

At 2123a-2123b, based on the network configuration, either the 5G-RG requested PDU session modification, or the 5G-RG requested PDU session establishment procedure is triggered.

At 2123a, the 5G-RG requested PDU session modification may be performed.

At 2123b, the 5G-RG requested PDU session establishment may be performed.

At 2124, in response to 2121, the operator portal returns a response to the 5G-RG subscription owner and/or the authorized user about the completion of the differentiated QoS request for the second non-3GPP device 2104.

In an implementation, an identifiable non-3GPP (IN3) device (e.g., the non-3GPP device) is provided with an IN3 identifier. The IN3 device may be a device that does not support non-access stratum (NAS) signaling, is connected to the 5GC via the RG, and may be individually identified but not authenticated by the 5GS to provide differentiated QoS.

For traffic from the IN3 device connected to the 5G-RG, the IN3 device identifier in the URSP rule may be matched against the device identifier that the IN3 device is associated with. When the SMF receives the IN3 device identifier from the UE, the SMF requests to update (Npcf_SMPolicyControl_Update) the SM policy association and provides the IN3 device identifier to the PCF.

When the UE requests differentiated QoS handling for the individual IN3 devices, the PDU session modification request includes the IN3 device identifier and the user plane address of the IN3 device.

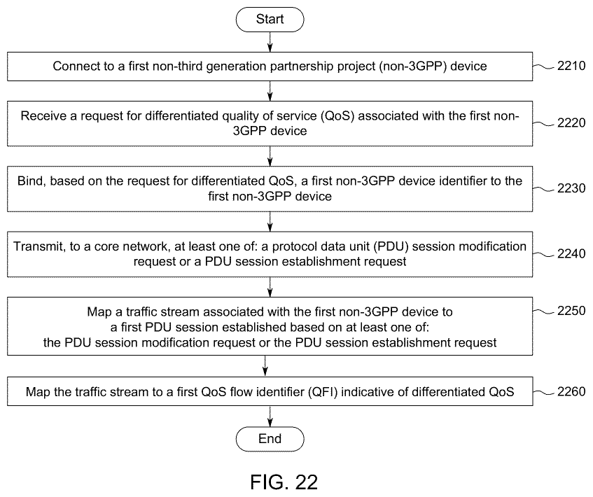

Referring now to FIG. 22, a flowchart illustrating a process for providing differentiated QoS to a non-3GPP device is shown according to one or more embodiments. The process may be performed by the RG, such as but not limited to the RG.

At 2210, the 5G-RG connects to a first non-3GPP device. In an example, the first non-3GPP device does not perform NAS signaling with the core network. In an example, the first non-3GPP device is connected by at least one of: a wireline connection or a wireless connection.

At 2220, the 5G-RG receives a request for differentiated QoS associated with the first non-3GPP device. The request for differentiated QoS is received from one or more of: an operator portal hosted in the RG, or an AF external to the RG.

At 2230, the 5G-RG binds, based on the request for differentiated QoS, a first non-3GPP device identifier to the first non-3GPP device. The first non-3GPP device identifier may be provisioned by the AF.

At 2240, the 5G-RG transmits, to a core network, at least one of: a PDU session modification request or a PDU session establishment request. The at least one of: the PDU session modification request or the PDU session establishment request includes the first non-3GPP device identifier.

At 2250, the 5G-RG maps a traffic stream associated with the first non-3GPP device to a first PDU session. The first PDU session is established based on at least one of: the PDU session modification request or the PDU session establishment request.

At 2260, the 5G-RG maps the traffic stream to a first QFI indicative of differentiated QoS.

In an implementation, initially, the non-3GPP device may be associated with a default QFI. The default QFI is shared with one or more non-3GPP devices. In that case, the PDU session modification request is indicative of modifying the default QFI to the first QFI for providing differentiated QoS in the first PDU session. The first QFI may be provisioned by the AF into the UDR in the core network.

In an implementation, the 5G-RG connects to a set of non-3GPP devices. The 5G-RG receives a set of requests for differentiated QoS associated with a set of non-3GPP devices. The 5G-RG binds, based on the set of requests, a set of non-3GPP device identifiers to the set of non-3GPP devices. The 5G-RG maps, based on the set of requests, the set of traffic streams to a set of QFIs indicative of differentiated QoS.

In an implementation, the 5G-RG maps at least one of: the set of non-3GPP devices or the first non-3GPP device to a CGI.

In an implementation, the 5G-RG provides differentiated QoS to the set of non-3GPP devices in the first PDU session and/or provides differentiated QoS to the set of non-3GPP devices across a set of PDU sessions.

What is claimed is:

1. A method performed by a residential gateway (RG), the method comprising:
connecting to a first non-third generation partnership project (non-3GPP) device;
receiving a request for differentiated quality of service (QoS) associated with the first non-3GPP device;
binding, based on the request for differentiated QoS, a first non-3GPP device identifier to the first non-3GPP device;
transmitting, to a core network, at least one of: a protocol data unit (PDU) session modification request or a PDU session establishment request;
mapping a traffic stream associated with the first non-3GPP device to a first PDU session established based on at least one of: the PDU session modification request or the PDU session establishment request; and
mapping the traffic stream to a first QoS flow identifier (QFI) indicative of differentiated QoS.

2. The method of claim 1, wherein at least one of: the PDU session modification request or the PDU session establishment request includes the first non-3GPP device identifier.

3. The method of claim 1, wherein the first non-3GPP device is associated with a default QFI.

4. The method of claim 3, wherein the default QFI is shared with one or more non-3GPP devices.

5. The method of claim 4, wherein the PDU session modification request is indicative of modifying the default QFI to the first QFI for providing differentiated QoS in the first PDU session.

6. The method of claim 1, wherein the request for differentiated QoS is received from one or more of:
an operator portal hosted in the RG, or
an application function (AF) external to the RG.

7. The method of claim 6, wherein the first non-3GPP device identifier is provisioned by the AF.

8. The method of claim 1, the method further comprising:
connecting to a set of non-3GPP devices;
receiving, a set of requests for differentiated QoS associated with a set of non-3GPP devices;
binding, based on the set of requests, a set of non-3GPP device identifiers to the set of non-3GPP devices; and
mapping, based on the set of requests, the set of traffic streams to a set of QFIs indicative of differentiated QoS.

9. The method of claim 8, the method further comprising:
mapping at least one of: the set of non-3GPP devices or the first non-3GPP device to a connectivity group identifier (CGI).

10. The method of claim 9, further comprising at least one of:
providing differentiated QoS to the set of non-3GPP devices in the first PDU session; or
providing differentiated QoS to the set of non-3GPP devices across a set of PDU sessions.

11. The method of claim 1, wherein the first non-3GPP device does not perform non-access stratum (NAS) signaling with the core network.

12. The method of claim 1, wherein the first non-3GPP device is connected by at least one of: a wireline connection or a wireless connection.

13. An apparatus comprising:
a memory;
a transceiver; and
a processor, wherein the transceiver and the processor are configured to:
connecting to a first non-third generation partnership project (non-3GPP) device,
receive a request for differentiated quality of service (QoS) associated with the first non-3GPP device,
bind, based on the request for differentiated QoS, a first non-3GPP device identifier to the first non-3GPP device,
transmit, to a core network, at least one of: a protocol data unit (PDU) session modification request or a PDU session establishment request,
map a traffic stream associated with the first non-3GPP device to a first PDU session established based on at least one of: the PDU session modification request or the PDU session establishment request, and
map the traffic stream to a first QoS flow identifier (QFI) indicative of differentiated QoS.

14. The apparatus of claim 13, wherein the apparatus is a residential gateway (RG).

15. The apparatus of claim 14, wherein the request for differentiated QoS is received from one or more of:
an operator portal hosted in the RG, or
an application function (AF) external to the RG.

16. The apparatus of claim 15, wherein the first non-3GPP device identifier is provisioned by the AF.

17. The apparatus of claim 13, wherein at least one of: the PDU session modification request or the PDU session establishment request includes the first non-3GPP device identifier.

18. The apparatus of claim 13, wherein the PDU session modification request is indicative of modifying a default QFI to the first QFI for providing differentiated QoS in the first PDU session.

19. The apparatus of claim 13, wherein the transceiver and the processor are further configured to:
connect to a set of non-3GPP devices,
receive, a set of requests for differentiated QoS associated with a set of non-3GPP devices,
bind, based on the set of requests, a set of non-3GPP device identifiers to the set of non-3GPP devices, and
map, based on the set of requests, the set of traffic streams to a set of QFIs indicative of differentiated QoS.

20. The apparatus of claim 19, wherein the transceiver and the processor are further configured to at least one of:
provide differentiated QoS to the set of non-3GPP devices in the first PDU session, or
provide differentiated QoS to the set of non-3GPP devices across a set of PDU sessions.
